(19) United States
(12) Patent Application Publication
(10) Pub. No.: US 2025/0159728 A1
(43) Pub. Date: May 15, 2025

(54) COMMUNICATION METHOD AND APPARATUS

(71) Applicant: SPREADTRUM COMMUNICATIONS (SHANGHAI) CO., LTD., Shanghai (CN)

(72) Inventor: Qufang HUANG, Shanghai (CN)

(73) Assignee: SPREADTRUM COMMUNICATIONS (SHANGHAI) CO., LTD., Shanghai (CN)

(21) Appl. No.: 18/725,369

(22) PCT Filed: Dec. 28, 2022
(86) PCT No.: PCT/CN2022/142818

§ 371 Date: Jun. 28, 2024

(30) Foreign Application Priority Data
Dec. 30, 2021 (CN) 202111644759.X

(51) Int. Cl. H04W 74/0833; H04L 1/1812

(52) U.S. Cl. CPC H04W 74/0833; H04L 1/1812

(57) ABSTRACT

Disclosed are a communication method and apparatus, relating to the technical field of communications. The method includes: determining, by a terminal device, a first resource; and requesting, by the terminal device, a second resource from a network device using the first resource. The first resource is located in a data transmission time window. The data transmission time window is used to receive downlink information. The second resource is used to send uplink information. In the method provided in embodiments of the present disclosure, an uplink resource can be requested by using a resource located in a data transmission time window, to reduce additional power consumption caused by requesting the uplink resource by the terminal device, and further reduce power consumption of the terminal device.

### CROSS-REFERENCE TO RELATED APPLICATIONS

The present disclosure claims priority to Chinese Patent Application No. 202111644759.X, filed with the China National Intellectual Property Administration on Dec. 30, 2021 and entitled “COMMUNICATION METHOD AND APPARATUS”, which is incorporated herein by reference in its entirety.

### TECHNICAL FIELD

Embodiments of the present disclosure relate to the technical field of communications, and in particular, to a communication method and apparatus.

### BACKGROUND

As capabilities of a terminal device are continuously enhanced, the terminal device can support an extended reality (XR) service. The terminal device supporting the XR service may be referred to as an XR terminal device. For example, the XR terminal device may be a virtual reality (VR) terminal device, an augmented reality (AR) terminal device, or the like.

Usually, for an XR terminal device powered by a battery, a discontinuous reception (DRX) mechanism is introduced for an XR service featuring periodic downlink transmission, such as a video service, to reduce energy consumption of downlink transmission, and further prolong a service life of the battery.

However, for uplink transmission of the XR service, generation of uplink data is usually related to random user behavior. Therefore, research on uplink transmission has important practical significance for further reducing power consumption of the XR terminal device and enhancing endurance of the XR terminal device.

### SUMMARY

Embodiments of the present disclosure provide a communication method and apparatus. An uplink resource can be requested by using a resource located in a data transmission time window, to help to reduce additional power consumption caused by requesting the uplink resource by a terminal device, and further help to reduce power consumption of the terminal device.

According to a first aspect, the embodiments of the present disclosure provide a communication method, including: determining, by a terminal device, a first resource, where the first resource is located in a data transmission time window, and the data transmission time window is used to receive downlink information; and requesting, by the terminal device, a second resource from a network device by using the first resource, where the second resource is used to send uplink information.

In the embodiments of the present disclosure, the first resource located in the data transmission time window is determined and an uplink resource can be requested by using the first resource located in the data transmission time window, to help to reduce additional power consumption caused by requesting the uplink resource by the terminal device, and further help to reduce power consumption of the terminal device.

In an embodiment, the method further includes: determining, by the terminal device, that an amount of resources required to send the uplink information exceeds an amount of resources actually available to send the uplink information.

In an embodiment, the method further includes: determining, by the terminal device, that there is uplink information to be sent.

In an embodiment, the method further includes: determining, by the terminal device, that no resource is available to send the uplink information.

In an embodiment, that the first resource is located in the data transmission time window and the data transmission time window is used to receive the downlink information includes: the first resource is located in an N^{th} data transmission time window. The N^{th} data transmission time window is used to receive a K^{th} transport block (TB). The first resource is used to send hybrid automatic repeat request (HARQ) information of the K^{th} TB. N and K are positive integers.

In the embodiments of the present disclosure, the terminal device requests the second resource by using the resource used to sending the HARQ information of the K^{th} TB and located in the data transmission time window. This helps the terminal device to quickly request the second resource and helps to reduce the power consumption of the terminal device.

In an embodiment, the method further includes: receiving, by the terminal device, first indication information from the network device, where the first indication information is used to indicate the K.

In an embodiment, the first resource includes a first sub-resource and a second sub-resource. The first sub-resource and the second sub-resource are used to send the HARQ information of the K^{th} TB.

In an embodiment, said requesting, by the terminal device, the second resource from the network device by using the first resource includes: sending, by the terminal device, the HARQ information of the K^{th} TB by using the first sub-resource.

In the embodiments of the present disclosure, the terminal device sends the HARQ information of the K^{th} TB by using the first sub-resource. This can implicitly request the second resource from the network device and helps to reduce signaling overheads of the terminal device.

In an embodiment, the method further includes: if the terminal device does not need to request the second resource, sending, by the terminal device, the HARQ information of the K^{th} TB by using the second sub-resource.

In an embodiment, said requesting, by the terminal device, the second resource from the network device by using the first resource includes: sending, by the terminal device, a resource request message to the network device on the first resource, where the resource request message is used to request the second resource.

In an embodiment, the method further includes: receiving, by the terminal device, uplink resource request configuration information from the network device, where the uplink resource request configuration information is used to indicate requesting the second resource by using the first resource.

In an embodiment, the method further includes: receiving, by the terminal device, resource configuration information from the network device, where the resource configuration information is used to indicate the second resource.

In an embodiment, the method further includes: sending, by the terminal device, a random access request to the network device if the terminal device requests the second resource by using M first resources but still receives no resource configuration information from the network device, where the random access request is used to request the second resource, and M is a positive integer.

In the embodiments of the present disclosure, the terminal device initiates random access after failing to request the second resource by using M first resources. This helps the terminal device to obtain the second resource and send the uplink information as soon as possible.

In an embodiment, the first resource is a scheduling request (SR) resource and/or a physical random access channel (PRACH) resource.

In an embodiment, said determining, by the terminal device, the first resource includes: if the SR resource and the PRACH resource are included in the data transmission time window, determining, by the terminal device, that the SR resource is the first resource; if the SR resource and the PRACH resource are included in the data transmission time window, determining, by the terminal device, that the SR resource and the PRACH resource are the first resource; or if the SR resource and the PRACH resource are included in the data transmission time window, determining, by the terminal device based on a configuration of the network device, that the SR resource or the PRACH resource is the first resource.

In an embodiment, the data transmission time window is located in a first time period. Duration of the first time period is longer than duration of the data transmission time window. A start moment of the first time period is a moment at which the terminal device needs to request the second resource.

In an embodiment, said determining, by the terminal device, the first resource includes: if there is no SR resource in the data transmission time window in the first time period and/or no PRACH resource in the data transmission time window in the first time period, determining, by the terminal device, that an SR resource and/or a PRACH resource closest to the moment at which the terminal device needs to request the second resource is the first resource.

In an embodiment, the method further includes: in response to expiring of a first timer, if the terminal device still receives no resource configuration information used to indicate the second resource from the network device, requesting, by the terminal device, the second resource from the network device by using an SR resource and/or a PRACH resource in any time period, where the first timer starts when the terminal device determines that there is uplink information to be sent.

According to a second aspect, the embodiments of the present disclosure further provide a communication method, including: detecting, by a network device by using a first resource, that a terminal device requests a second resource, where the first resource is located in a data transmission time window, the data transmission time window is used to send downlink information, and the second resource is used to send uplink information.

In an embodiment, the method further includes: sending, by the network device, uplink resource request configuration information to the terminal device, where the uplink resource request configuration information is used to indicate requesting the second resource by using the first resource.

In an embodiment, that the first resource is located in the data transmission time window and the data transmission time window is used to send the downlink information includes: the first resource is located in an N^{th} data transmission time window. The N^{th} data transmission time window is used to send a K^{th} TB. The first resource is used to send HARQ information of the K^{th} TB. N and K are positive integers.

In an embodiment, the method further includes: sending, by the network device, first indication information to the terminal device, where the first indication information is used to indicate the K.

In an embodiment, the first resource includes a first sub-resource and a second sub-resource. The first sub-resource and the second sub-resource are used to send the HARQ information of the K^{th} TB.

In an embodiment, the method further includes: if the network device receives the HARQ information of the K^{th} TB on the first sub-resource, determining, by the network device, that a request of the terminal device for the second resource is detected.

In an embodiment, the method further includes: if the network device receives the HARQ information of the K^{th} TB on the second sub-resource, determining, by the network device, that no request of the terminal device for the second resource is detected.

In an embodiment, said detecting, by the network device on the first resource, that the terminal device requests the second resource includes: receiving, by the network device, a resource request message from the terminal device on the first resource, where the resource request message is used to request the second resource.

In an embodiment, the method further includes: sending, by the network device, resource configuration information to the terminal device, where the resource configuration information is used to indicate the second resource.

In an embodiment, the first resource is an SR resource and/or a PRACH resource.

In an embodiment, the method further includes: sending, by the network device, priority indication information to the terminal device, where the priority indication information indicates a priority of using the SR resource and a priority of using the PRACH resource to request the second resource.

In an embodiment, the data transmission time window is located in a first time period. Duration of the first time period is longer than duration of the data transmission time window. A start moment of the first time period is a moment at which the terminal device needs to request the second resource.

In an embodiment, the method further includes: sending, by the network device, window adjustment indication information to the terminal device, where the window adjustment indication information indicates aligning a start moment of a DRX window with a moment at which the downlink information arrives.

According to a third aspect, the embodiments of the present disclosure provide a communication apparatus, including a processor and a memory. The memory is configured to store a computer program. The processor is configured to run the computer program to perform the communication method according to the first aspect.

According to a fourth aspect, the embodiments of the present disclosure further provide a communication apparatus, including a processor and a memory. The memory is configured to store a computer program. The processor is configured to run the computer program to perform the communication method according to the second aspect.

According to a fifth aspect, the embodiments of the present disclosure provide a computer-readable storage medium. The computer-readable storage medium stores a computer program. When the computer program runs on a computer, the computer is enabled to implement the communication method according to the first aspect or the second aspect.

According to a sixth aspect, the embodiments of the present disclosure provide a computer program product. The computer program product includes a computer program. When the computer program is executed by a computer, the computer is enabled to implement the communication method according to the first aspect or the second aspect.

In an embodiment, the program in the sixth aspect may be completely or partially stored on a storage medium packaged with a processor or may be completely or partially stored on a memory not packaged with a processor.

According to a seventh aspect, the embodiments of the present disclosure provide a communication apparatus, including one or more functional modules. The one or more functional modules are configured to perform any communication method according to the first aspect.

According to an eighth aspect, the embodiments of the present disclosure provide a communication apparatus, including one or more functional modules. The one or more functional modules are configured to perform any communication method according to the second aspect.

According to a ninth aspect, a communication system is provided, including a communication apparatus configured to perform any method according to the first aspect and a communication apparatus configured to perform any method according to the second aspect.

The communication apparatus in the third and seventh aspects may be a chip or a terminal device. The communication apparatus in the fourth and eighth aspects may be a chip or a network device.

### BRIEF DESCRIPTION OF DRAWINGS

FIG. 1a is a schematic diagram of an embodiment of a DRX cycle according to the present disclosure;

FIG. 1b is a schematic diagram of another embodiment of a DRX cycle according to the present disclosure;

FIG. 2 is a schematic diagram of a network architecture of a communication system according to an embodiment of the present disclosure;

FIG. 3 is a schematic flowchart of an embodiment of a communication method according to the present disclosure;

FIG. 4 is a schematic flowchart of another embodiment of a communication method according to the present disclosure;

FIG. 5 is a schematic diagram of an embodiment of a method for requesting an uplink resource according to the present disclosure;

FIG. 6 is a schematic flowchart of still another embodiment of a communication method according to the present disclosure;

FIG. 7 is a schematic diagram of another embodiment of a method for requesting an uplink resource according to the present disclosure;

FIG. 8 is a schematic flowchart of a method for determining a first resource according to an embodiment of the present disclosure;

FIG. 9 is a schematic structural diagram of an embodiment of a communication apparatus according to the present disclosure;

FIG. 10 is a schematic structural diagram of another embodiment of a communication apparatus according to the present disclosure; and

FIG. 11 is a schematic structural diagram of still another embodiment of a communication apparatus according to the present disclosure.

### DESCRIPTION OF EMBODIMENTS

The following describes the technical solutions in the embodiments of the present disclosure with reference to the accompanying drawings in the embodiments of the present disclosure. In descriptions of the embodiments of the present disclosure, unless otherwise specified, “/” means or. For example, A/B may represent A or B. The term “and/or” in this specification merely describes an association relationship between associated objects and indicates that there may be three relationships. For example, A and/or B may represent the following three cases: Only A exists, both A and B exist, and only B exists.

It should be noted that in the embodiments of the present disclosure, terms such as “first” and “second” are merely used for a purpose of distinction in description, and should not be understood as an indication or implication of relative importance, an implicit indication of a quantity of indicated technical features, or an indication or implication of a sequence. In the embodiments of the present disclosure, “at least one” means one or more, and “a plurality of” means two or more.

In addition, “at least one of the following items (pieces)” or a similar expression thereof indicates any combination of these items, which may include a single item (piece) or any combination of a plurality of items (pieces). For example, at least one of A, B, or C may represent A, B, C, A and B, A and C, B and C, or A, B, and C. Each of A, B, and C may be an element or a set including one or more elements.

In the embodiments of the present disclosure, “example”, “in some embodiments”, “in another embodiment”, or the like is used to represent giving an example, an illustration, or a description. Any embodiment or design scheme described as an “example” in the present disclosure should not be explained as being more preferred or having more advantages than another embodiment or design scheme. Exactly, the word “example” is used to present a concept in a specific manner.

In the embodiments of the present disclosure, “of”, “relevant”, and “corresponding” may sometimes be used interchangeably. It should be noted that when a difference between them is not emphasized, they have a same meaning. In the embodiments of the present disclosure, communication and transmission may sometimes be used interchangeably. It should be noted that when a difference between them is not emphasized, they have a same meaning. For example, transmission may include sending and/or receiving, and may be in a form of a noun or verb.

In the embodiments of the present disclosure, “equal to” may be used with “greater than”, applicable to the technical solution “greater than”; or may be used with “less than”, applicable to the technical solution “less than”. It should be noted that “equal to” cannot be used with “less than” and “greater than” simultaneously.

First, some terms in the embodiments of the present disclosure are described to facilitate understanding by those skilled in the art.
1. Terminal device in the embodiments of the present disclosure is a device having a wireless transceiving function, and may be referred to as a terminal, user equipment (UE), a mobile station (MS), a mobile terminal (MT), an access terminal device, a vehicle-mounted terminal device, an industrial control terminal device, a UE unit, a UE station, a mobile platform, a remote station, a remote terminal device, a mobile device, a UE terminal device, a wireless communication device, a UE proxy, a UE apparatus, or the like. The terminal device may be stationary or mobile. It should be noted that the terminal device may support at least one wireless communication technology, such as long term evolution (LTE) and new radio (NR). For example, the terminal device may be a mobile phone, a tablet computer, a desktop computer, a notebook computer, an all-in-one machine, a vehicle-mounted terminal, a VR terminal device, an AR terminal device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular telephone, a cordless phone, a session initiation protocol (SIP) phone, a wireless local loop (WLL) station, a personal digital assistant (PDA), a handheld device having a wireless communication function, a computing device or another processing device connected to a wireless modem, a wearable device, a terminal device in a future mobile communication network, a terminal device in a future evolved public land mobile network (PLMN), or the like. In some embodiments of the present disclosure, the terminal device may alternatively be an apparatus having a transceiving function, such as a chip system. The chip system may include a chip, and may further include another discrete component.
2. Network device in the embodiments of the present disclosure is a device that provides a wireless communication function for a terminal device, and may also be referred to as an access network device, a radio access network (RAN) device, or the like. The network device may support at least one wireless communication technology, such as LTE and NR. For example, the network device includes but is not limited to a gNodeB (gNB) in a 5th-generation (5G) mobile communication system, an evolved NodeB (eNB), a radio network controller (RNC), a NodeB (NB), a base station controller (BSC), a base transceiver station (BTS), a home base station (such as a home eNB or a home NB (HNB)), a baseband unit (BBU), a transmitting and receiving point (TRP), a transmitting point (TP), and a mobile switching center. Alternatively, the network device may be a radio controller, a centralized unit (CU), and/or a distributed unit (DU) in a cloud RAN (CRAN) scenario; or may be a relay station, an access point, a vehicle-mounted device, a terminal device, a wearable device, a network device in future mobile communication, a network device in a future evolved PLMN, or the like. In some embodiments, the network device may alternatively be an apparatus that provides a wireless communication function for a terminal device, such as a chip system. For example, the chip system may include a chip, and may further include another discrete component.
3. Uplink information in the embodiments of the present disclosure may also be referred to as an uplink signal. For example, the uplink information may include uplink control information (UCI) and/or uplink data. The UCI is used to carry information fed back by a terminal device, such as channel state information (CSI), an SR, a preamble, an acknowledgement (ACK)/negative acknowledgement (NACK), and the like. Specifically, the UCI may be carried on a physical uplink control channel (PUCCH) or a physical uplink shared channel (PUSCH). The uplink data may include data related to a service. Specifically, the uplink data may be carried on the PUSCH. For example, for an XR service, the uplink data may be data related to user behavior.
4. Downlink information in the embodiments of the present disclosure may also be referred to as a downlink signal. For example, the downlink information may include downlink control information (DCI) and/or downlink data. The DCI is information used to schedule the downlink data, such as resource allocation and a modulation and coding scheme of a data channel. Specifically, the DCI may be carried on a physical downlink control channel (PDCCH). The downlink data may be carried on a physical downlink shared channel (PDSCH). The downlink data may include data related to a service. For example, for an XR service, the downlink data may be a video frame of the XR service.
5. In the embodiments of the present disclosure, the data transmission time window is used to receive downlink information for a terminal device; and is used to send the downlink information for a network device. In the embodiments of the present disclosure, the data transmission time window occurs periodically. For example, the data transmission time window may be understood as an active period in a DRX cycle. In this case, a cycle of the data transmission time window is the same as that of the active period.

A DRX cycle may be divided into an active period and a sleep period based on behavior of a terminal device. The active period in the DRX cycle may be referred to as a DRX active period for short. The sleep period in the DRX cycle may be referred to as a DRX sleep period for short. In the DRX active period, a network device may send downlink information to the terminal device, and the terminal device may receive the downlink information sent by the network device. In the DRX sleep period, the network device does not send downlink information to the terminal device, and the terminal device may be in a sleep state, that is, does not receive downlink information from the network device. This can reduce power consumption of the terminal device.

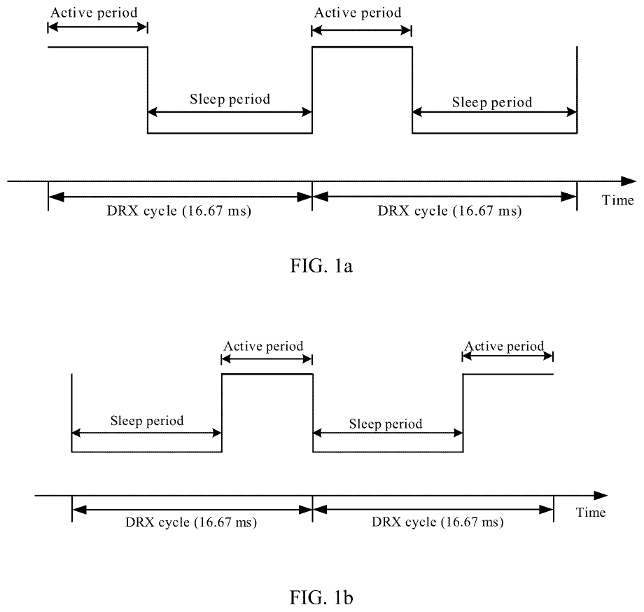

It can be understood that the terminal device may periodically receive downlink information sent by the network device in the DRX active period. For example, for an XR service, downlink video data of the XR service is generated periodically. 60 frames of downlink video data are generated in 1 second. In other words, one frame of downlink video data is generated every 16.67 ms. The network device may send one frame of downlink video data in one DRX cycle. In other words, the DRX cycle may be a cycle of one frame of downlink video data, for example, 16.67 ms. FIG. 1a and FIG. 1b are schematic diagrams of a DRX cycle in the XR service. In the DRX cycle shown in FIG. 1a, the DRX active period is before the DRX sleep period. In the DRX cycle shown in FIG. 1b, the DRX active period is after the DRX sleep period.

In the embodiments of the present disclosure, the ACK/NACK resource is used to send HARQ information for a terminal device, and the ACK/NACK resource is used to receive the HARQ information for a network device. A TB of video data is used as an example. For the terminal device, the ACK/NACK resource is used to send HARQ information of the TB of the video data. The HARQ information is used to indicate a reception status of the TB of the video data. For example, if the terminal device correctly receives the TB of the video data, the HARQ information is an ACK. For another example, if the terminal device fails to receive the TB of the video data, the HARQ information is a NACK.

In the embodiments of the present disclosure, the SR resource is an uplink resource used to send an SR. For example, the SR resource may be a PUSCH resource. The SR is sent by a terminal device to a network device. The SR may be used to request the network device for a resource for sending uplink information. It can be understood that the SR resource is usually periodic. The terminal device may use any one or more SR resources to send an SR to the network device. For example, after detecting that an SR resource exists, the terminal device may use the SR resource to send an SR to the network device according to a requirement. For example, the requirement may be whether there is uplink information to be sent.

In the embodiments of the present disclosure, the PRACH resource is a resource for initiating random access. For example, the PRACH resource may include a preamble and a random access channel (RACH) occasion (RO). The RO may be a resource including a frequency domain and a time domain.

A video service is a downlink transmission XR service with periodicity. In other words, downlink video data of the video service is usually transmitted periodically. To reduce power consumption of a terminal device, the terminal device usually receives downlink video data sent by a network device under a DRX mechanism. For example, the terminal device may receive the downlink video data during an active period in a DRX cycle and stop receiving the downlink video data during a sleep period in the DRX cycle.

However, in a process of performing the XR service, the terminal device usually sends uplink data to the network device. The uplink data may be data related to user behavior. It can be understood that the user behavior is usually random. The terminal device cannot periodically send the uplink data related to the user behavior. Consequently, the terminal device cannot send the uplink data in power saving mode, such as the DRX cycle. In this case, to send the uplink data related to the user behavior, the terminal device needs to request a resource for sending the uplink data related to the user behavior from the network device in advance. Requesting the network device for the resource by the terminal device causes additional power consumption of the terminal device. The terminal device is usually a wearable device, for example, an XR device. The XR device is sensitive to power consumption and consumes a large amount of power in the video service. Therefore, the additional power consumption further burdens the XR device, resulting in poor endurance of the XR device.

In view of the foregoing problem, the embodiments of the present disclosure provide a communication method such that a terminal device can request an uplink resource from a network device using a resource in a data transmission time window used to receive downlink data, to reduce additional power consumption caused by requesting the uplink resource by the terminal device, and further reduce power consumption of the terminal device.

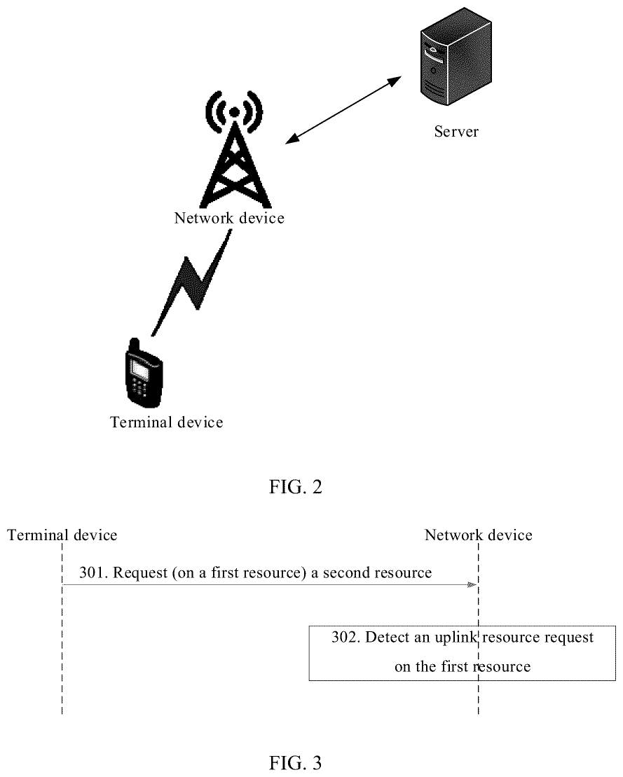

FIG. 2 is a diagram of a network architecture of a communication system according to an embodiment of the present disclosure. The communication system includes a terminal device, a network device, and a server. It should be noted that the server may be a local server or a cloud server. A server that supports an XR service may also be referred to as an XR server. For example, the XR service is a video service. The terminal device may send information related to behavior of a user (such as an action of the user) to the server through the network device in response to the behavior of the user. The server may send relevant video data to the network device based on the information related to the behavior of the user. The network device sends the video data to the terminal device. In this way, the terminal device receives the video data from the server, and displays a corresponding video image based on the received video data in response to the behavior of the user.

FIG. 2 is merely an example of the communication system in the embodiments of the present disclosure, and the embodiments of the present disclosure are not limited thereto. For example, the communication system in the embodiments of the present disclosure may include a plurality of network devices, and may further include a plurality of terminal devices.

The following describes the communication method in the embodiments of the present disclosure by using the communication system shown in FIG. 2 as an example.

FIG. 3 is a schematic flowchart of a communication method according to an embodiment of the present disclosure. The method specifically includes the following steps.

In step 301, a terminal device requests, using a first resource, a second resource from a network device. The first resource is located in a data transmission time window. The data transmission time window is used to receive downlink information. The second resource is used to send uplink information. In other words, the second resource is an uplink resource.

In some embodiments, the terminal device may be triggered in the following manners to request for the second resource from the network device by using the first resource.

In manner 1, if the terminal device determines that there is uplink information to be sent, the terminal device requests the second resource from the network device by using the first resource. For example, the uplink information is XR service data. The terminal device detects user behavior and generates XR service data related to the user behavior. In this case, the terminal device may request the second resource from the network device by using the first resource in response to the user behavior; or may request the second resource from the network device by using the first resource after generating the XR service data related to the user behavior in response to the user behavior. For example, the terminal device may detect the user behavior through a camera or one or more sensors (such as an acceleration sensor, a gyroscope, and the like). A manner in which the terminal device detects the user behavior is not specifically limited in the embodiments of the present disclosure.

In manner 2, if the terminal device determines that an amount of resources required to send the uplink information exceeds an amount of resources actually available to send the uplink information, the terminal device requests the second resource from the network device by using the first resource. In other words, if an actual amount of required uplink resources is greater than an actual amount of available uplink resources, the terminal device requests the second resource from the network device by using the first resource. For example, if the terminal device has uplink information to be sent, the terminal device first determines whether the actual amount of available uplink resources meets the amount of resources required to send the uplink information. If the actual amount of available uplink resources does not meet the amount of resources required to send the uplink information, the terminal device requests the second resource from the network device by using the first resource. Further, in some embodiments, a resource amount of the second resource requested by the terminal device from the network device by using the first resource may be a difference between the amount of resources required to send the uplink information and the amount of resources actually available to send the uplink information. In some other embodiments of the present disclosure, if the amount of resources required to send the uplink information does not exceed the amount of resources actually available to send the uplink information, the terminal device does not need to request an uplink resource from the network device.

In manner 3, if there is no resource available to send the uplink information, the terminal device requests the second resource from the network device by using the first resource. In other words, if the terminal device determines that there is no available uplink resource, the terminal device requests the second resource from the network device by using the first resource. In this case, the terminal device may not determine whether there is uplink information to be sent. If there is no uplink information to be sent and the terminal device has no available uplink resource, the terminal device may be triggered to request the second resource from the network device by using the first resource.

In some alternative embodiments of the present disclosure, the terminal device may be triggered in another manner to request the second resource from the network device by using the first resource. This is not limited in the embodiments of the present disclosure.

In some embodiments of the present disclosure, the terminal device may first determine the first resource, and then request the second resource from the network device by using the first resource. For example, if the terminal device determines that there is no available uplink resource, the terminal device may first determine the first resource, and then request the second resource from the network device by using the first resource.

For example, the network device sends resource request configuration information to the terminal device. The resource request configuration information is used to indicate requesting the second resource by the first resource. In this case, after receiving the resource request configuration information, the terminal device may determine the first resource based on the resource request configuration information. For another example, requesting the second resource by the first resource may be predefined through a protocol. In this case, the terminal device may determine the first resource based on a predefined configuration.

In step 302, the network device detects an uplink resource request by using the first resource. That is, the network device detects, by using the first resource, that the terminal device requests the second resource.

Further, in some embodiments, the network device detects, by using the first resource, that the terminal device requests the second resource, and sends resource configuration information to the terminal device. The resource configuration information is used to indicate the second resource. Correspondingly, the terminal device receives the resource configuration information from the network device. In this way, the terminal device can send the uplink information on the second resource after receiving the resource configuration information.

It should be noted that because a DRX cycle is usually not an integer multiple of a slot, a time domain position of the DRX cycle cannot be aligned with a moment at which downlink information arrives. Consequently, the terminal device may be unable to effectively receive the downlink information from the network device in a data transmission time window of the DRX cycle. For example, for an XR service and a 5G network, a DRX cycle may be a cycle of one frame of downlink video data, such as 16.67 ms. A time length of a slot in the 5G network is 0.5 ms. In other words, the DRX cycle is not an integer multiple of the slot. Therefore, the network device may send position adjustment indication information to the terminal device, which is used to adjust the time domain position of the DRX cycle. In this way, a time domain position of a start moment of the data transmission time window in the DRX cycle is aligned with or consistent with a time domain position of a moment at which the downlink video data arrives. This improves efficiency of receiving the downlink video data by the terminal device in the data transmission time window. In specific implementation, a manner of adjusting the time domain position of the DRX cycle includes the following manner 1 or 2:

In manner 1, if the network device detects that a difference between the moment at which the downlink video data arrives and the start moment of the data transmission time window in the DRX cycle exceeds a threshold, the network device notifies the terminal device to adjust a time domain position of a start moment of the DRX cycle. The adjusted time domain position of the start moment of the DRX cycle may be determined based on the difference between the moment at which the downlink video data arrives and the start moment of the data transmission time window in the DRX cycle.

In manner 2, the network device may configure a drift speed of the DRX cycle for the terminal device. For example, the drift speed may be used to indicate the terminal device to adjust the time domain position of the DRX cycle forward or backward by X ms per second. X is a value of the drift speed. In this way, the terminal device can adjust the time domain position of the DRX cycle based on the drift speed. The drift speed may be determined based on the difference between the moment at which the downlink video data arrives and the start moment of the data transmission time window in the DRX cycle.

In the embodiments of the present disclosure, the first resource may include one or more of an ACK/NACK resource, an SR resource, and/or a PRACH resource.

In embodiment 1, an uplink resource is requested using an ACK/NACK resource located in a data transmission time window.

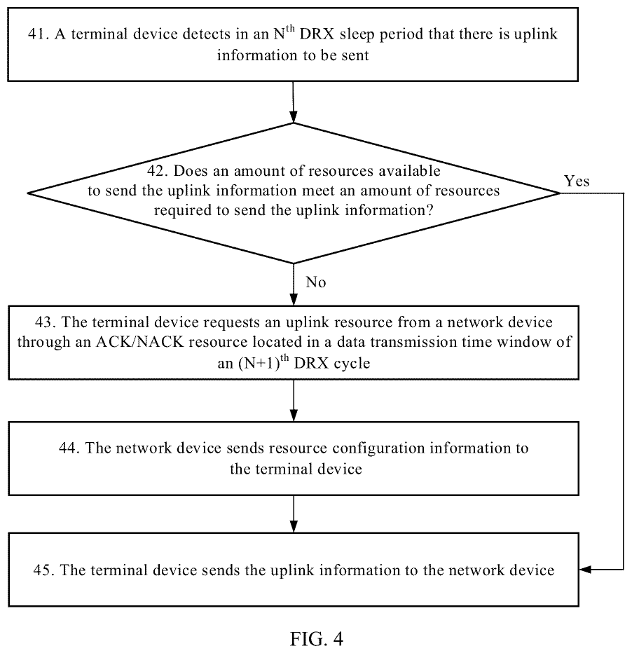

FIG. 4 is a schematic flowchart of a communication method according to an embodiment of the present disclosure. The method specifically includes the following steps.

In step 41, a terminal device detects in an N^{th} DRX sleep period that there is uplink information to be sent. N is a positive integer. For one DRX cycle, a sleep period is subsequent to an active period, as shown in FIG. 1a.

In step 42, the terminal device determines whether an amount of resources available to send the uplink information meets an amount of resources required to send the uplink information. If the amount of resources available to send the uplink information meets the amount of resources required to send the uplink information, step 45 is performed. If the amount of resources available to send the uplink information does not meet the amount of resources required to send the uplink information, step 43 is performed.

In step 43, the terminal device requests an uplink resource from a network device by using an ACK/NACK resource located in a data transmission time window of an (N+1)^{th} DRX cycle. Correspondingly, the network device detects on the ACK/NACK resource located in the data transmission time window of the (N+1)^{th} DRX cycle that the terminal device requests the uplink resource.

For example, the terminal device requests the uplink resource by using an ACK/NACK resource of a K^{th} TB in the data transmission time window. For example, K is 1, which may be predefined through a protocol or indicated by the network device. For example, the network device sends first indication information to the terminal device. The first indication information is used to indicate K. It should be noted that the K^{th} TB is the K^{th} TB received in the data transmission time window. Alternatively, the terminal device requests the uplink resource by using an ACK/NACK resource of two or more TBs in the data transmission time window. A quantity of TBs or an ACK/NACK resource of which TBs may be predefined through a protocol or indicated to the terminal device by the network device. This is not limited.

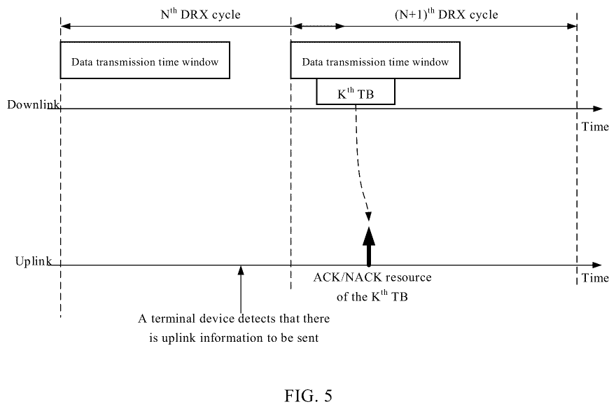

For example, as shown in FIG. 5, the terminal device detects in an N^{th} DRX cycle that there is uplink information to be sent. The terminal device determines that the amount of resources actually available to send the uplink information does not meet the amount of resources required to send the uplink information. The terminal device is triggered to request a second resource. Then, the network device sends downlink information to the terminal device in the data transmission time window of the (N+1)^{th} DRX cycle. It can be understood that the network device sends the downlink information to the terminal device through a TB. Therefore, after receiving the K^{th} TB in the data transmission time window, the terminal device can send HARQ information to the network device by using the ACK/NACK resource of the K^{th} TB in the data transmission time window. In this way, the terminal device can request the uplink resource from the network device by using the ACK/NACK resource of the K^{th} TB in the data transmission time window of the (N+1)^{th} DRX cycle.

In the embodiments of the present disclosure, the terminal device may implicitly or explicitly request the uplink resource from the network device by using the ACK/NACK resource located in the data transmission time window.

For example, the terminal device implicitly requests the uplink resource from the network device by using the ACK/NACK resource of the K^{th} TB in the data transmission time window. For example, the ACK/NACK resource of the K^{th} TB include a first sub-resource and a second sub-resource. The terminal device sends HARQ information of the K^{th} TB to the network device by using the first sub-resource. In this case, the terminal device requests the uplink resource. In other words, if the terminal device needs to request the uplink resource and has uplink information to be sent, the terminal device sends the HARQ information of the K^{th} TB by using the first sub-resource. If the network device receives the HARQ information of the K^{th} TB on the first sub-resource, the network device determines that a request of the terminal device for the uplink resource is detected. Alternatively, the terminal device sends the HARQ information of the K^{th} TB to the network device by using the second sub-resource. In this case, the terminal device does not request the uplink resource. In other words, if the terminal device does not need to request the uplink resource, the terminal device sends the HARQ information of the K^{th} TB by using the second sub-resource. If the network device receives the HARQ information of the K^{th} TB on the second sub-resource, the network device determines that no request of the terminal device for the uplink resource is detected.

For example, the terminal device may explicitly request the uplink resource from the network device by using the ACK/NACK resource located in the data transmission time window in the following manner.

The terminal device sends a resource request message to the network device on the ACK/NACK resource located in the data transmission time window. The resource request message is used to request the uplink resource.

In step 44, the network device sends resource configuration information to the terminal device. Correspondingly, the terminal device receives the resource configuration information from the network device. The resource configuration information is used to indicate the uplink resource.

In step 45, the terminal device sends the uplink information to the network device. Correspondingly, the network device receives the uplink information from the terminal device.

Further, in some embodiments, if the terminal device uses the ACK/NACK resource located in the data transmission time window for M times but still receives no resource configuration information from the network device, the terminal device sends a random access request message to the network device to initiate random access and request the uplink resource through a random access procedure. For example, the random access request message is used to request the uplink resource.

M is a positive integer. M may be indicated to the terminal device by the network device, predefined through a protocol, or determined by the terminal device based on a specific policy. This is not limited. It should be noted that the ACK/NACK resource used to request the uplink resource each time may be located in the same data transmission time window or different data transmission time windows. Alternatively, some resources may be located in the same data transmission time window, and some resources may be located in different data transmission time windows. This is not limited.

In addition, in some embodiments, the network device sends resource request configuration information to the terminal device. The resource request configuration information is used to indicate that the uplink resource is requested by the ACK/NACK resource. Alternatively, requesting the uplink resource by the ACK/NACK resource may be predefined through a protocol.

It should be noted that if a sleep period is before an active period for one DRX cycle, as shown in FIG. 1b, the terminal device detects in the N^{th} DRX sleep period that there is uplink information to be sent, and the amount of resources actually available to send the uplink information does not meet the amount of resources required to send the uplink information, the terminal device may request the uplink resource from the network device by using an ACK/NACK resource in an N^{th} DRX active period. That is, the terminal device may request the uplink resource from the network device by using an ACK/NACK resource in a data transmission time window of the N^{th} DRX cycle.

Alternatively, if the sleep period is before the active period, the terminal device detects in the N^{th} DRX sleep period that there is uplink information to be sent, and the amount of resources actually available to send the uplink information does not meet the amount of resources required to send the uplink information, the terminal device may request the uplink resource from the network device by using an ACK/NACK resource in an (N+1)^{th} DRX active period. That is, the terminal device may request the uplink resource from the network device by using the ACK/NACK resource in the data transmission time window of the (N+1)^{th} DRX cycle.

In Embodiment 2, an uplink resource is requested by using an SR resource and/or a PRACH resource located in a data transmission time window.

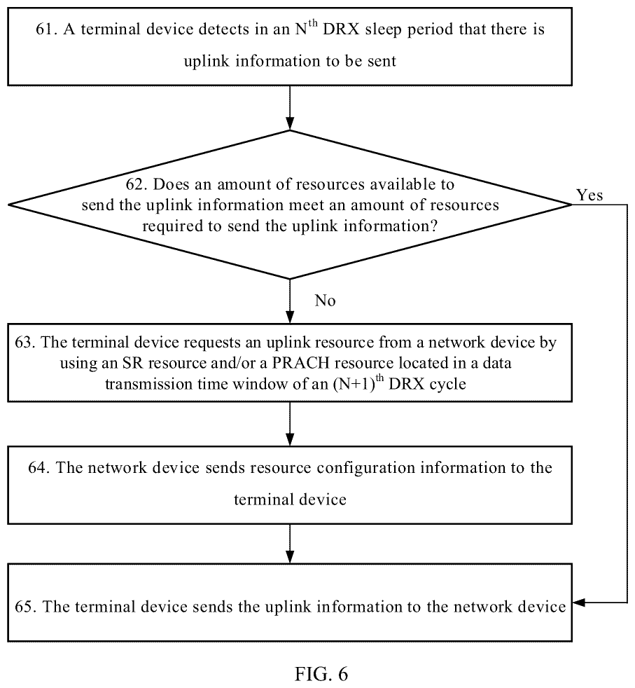

FIG. 6 is a schematic flowchart of a communication method according to an embodiment of the present disclosure. The method specifically includes the following steps.

In step 61, a terminal device detects in an N^{th} DRX sleep period that there is uplink information to be sent. N is a positive integer. For one DRX cycle, a sleep period is after an active period, as shown in FIG. 1a.

In step 62, the terminal device determines whether an amount of resources actually available to send the uplink information meets an amount of resources required to send the uplink information. If the amount of resources actually available to send the uplink information meets the amount of resources required to send the uplink information, step 65 is performed. If the amount of resources actually available to send the uplink information do not meet the amount of resources required to send the uplink information, step 63 is performed.

In step 63, the terminal device requests an uplink resource from a network device by using an SR resource and/or a PRACH resource located in a data transmission time window of an (N+1)^{th} DRX cycle. Correspondingly, the network device detects on the SR resource and/or the PRACH resource located in the data transmission time window of the (N+1)^{th} DRX cycle that the terminal device requests the uplink resource.

For example, the terminal device requests the uplink resource by using an L^{th} SR resource and/or PRACH resource in the data transmission time window. For example, a value of L is 1, which may be predefined through a protocol or indicated by the network device. For example, the network device sends second indication information to the terminal device. The second indication information is used to indicate L. It should be noted that the L^{th} SR resource and/or PRACH resource is the L^{th} SR resource and/or PRACH resource in the data transmission time window.

Alternatively, the terminal device requests the uplink resource by using two or more SR resources and/or PRACH resources in the data transmission time window. A quantity of SR resources and/or PRACH resources may be predefined through a protocol or indicated to the terminal device by the network device. This is not limited.

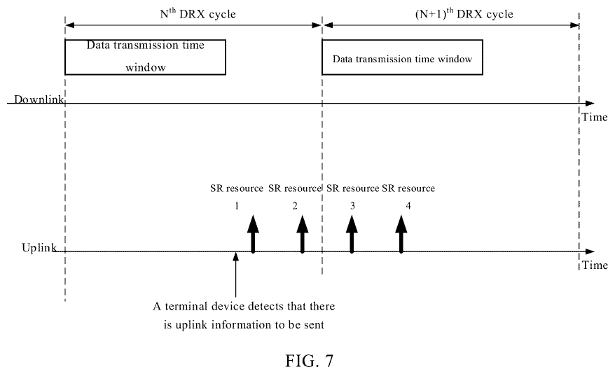

For example, as shown in FIG. 7, taking SR resources as an example, the terminal device detects in an N^{th} DRX cycle that there is uplink information to be sent. The terminal device determines that the amount of resources actually available to send the uplink information does not meet the amount of resources required to send the uplink information. The terminal device is triggered to request a second resource. Then, the terminal device detects SR resources in the data transmission time window of the (N+1)^{th} DRX cycle. An SR resource 1, SR resource 2, SR resource 3, and SR resource 4 are periodic SR resources. The SR resource 1 and SR resource 2 are located in the N^{th} DRX cycle. The SR resource 3 and SR resource 4 are located in the (N+1)^{th} DRX cycle. In this case, the terminal device may request the uplink resource from the network device by using the SR resource located in the data transmission time window of the (N+1)^{th} DRX cycle, for example, the SR resource 3 and/or SR resource 4.

In the embodiments of the present disclosure, the terminal device may request the uplink resource from the network device by using the SR resource and/or the PRACH resource located in the data transmission time window based on priorities of the SR resource and the PRACH resource.

For example, if both the SR resource and the PRACH resource are included in the data transmission time window and the priority of the SR resource is higher than that of the PRACH resource, the terminal device may preferentially select the SR resource as a first resource to request the uplink resource from the network device. The priorities of the SR resource and the PRACH resource may be predefined through a protocol or indicated to the terminal device by the network device. This is not limited.

For another example, if both the SR resource and the PRACH resource are included in the data transmission time window and the priority of the SR resource is lower than that of the PRACH resource, the terminal device may preferentially select the PRACH resource as the first resource to request the uplink resource from the network device. The priorities of the SR resource and the PRACH resource may be predefined through a protocol or indicated to the terminal device by the network device. This is not limited.

For another example, if both the SR resource and the PRACH resource are included in the data transmission time window and the priority of the SR resource is the same as that of the PRACH resource, the terminal device may select both the SR resource and the PRACH resource as the first resource to request the uplink resource from the network device. The priorities of the SR resource and the PRACH resource may be predefined through a protocol or indicated to the terminal device by the network device. This is not limited.

In some embodiments of the present disclosure, the terminal device may request the uplink resource from the network device by using the SR resource and/or the PRACH resource located in the data transmission time window in the following manner a or b.

In manner a, the terminal device sends a resource request message to the network device on the SR resource and/or the PRACH resource located in the data transmission time window. The resource request message is used to request the uplink resource.

In some embodiments, the network device may configure a maximum quantity of times of sending the resource request message. It can be understood that the maximum quantity of times of sending the resource request message has been configured in a current protocol. In the current protocol, the SR resource and/or the PRACH resource used to send the resource request message may be located in the entire DRX cycle. Therefore, the maximum quantity of times of sending the resource request message configured in the current protocol is large. In the embodiments of the present disclosure, the SR resource and/or the PRACH resource used to send the resource request message are located in the data transmission time window. In other words, an SR resource and/or a PRACH resource located outside the data transmission time window are not used in the embodiments of the present disclosure. Consequently, the SR resource and/or the PRACH resource used to send the resource request message are less than an SR resource and/or a PRACH resource specified in the current protocol. Therefore, the maximum quantity of times of sending the resource request message configured by the network device in the embodiments of the present disclosure may be less than the maximum quantity of times of sending the resource request message configured in the current protocol.

In manner b, the terminal device sends a preamble to the network device on the PRACH resource located in the data transmission time window. The preamble is used to request the uplink resource.

In step 64, the network device sends resource configuration information to the terminal device. Correspondingly, the terminal device receives the resource configuration information from the network device. The resource configuration information is used to indicate the uplink resource.

In step 65, the terminal device sends the uplink information to the network device. Correspondingly, the network device receives the uplink information from the terminal device.

Further, in some embodiments, if the terminal device uses the SR resource and/or the PRACH resource located in the data transmission time window for S times but still receives no resource configuration information from the network device, the terminal device may request the second resource from the network device by using any SR resource and/or PRACH resource in the DRX cycle. It can be understood that the any SR resource and/or PRACH resource in the DRX cycle may include the SR resource and/or the PRACH resource located in the data transmission time window or may include the SR resource and/or the PRACH resource located outside the data transmission time window.

S is a positive integer. S may be indicated to the terminal device by the network device, predefined through a protocol, or determined by the terminal device based on a specific policy. This is not limited.

In some other embodiments of the present disclosure, an SR resource and/or a PRACH resource are not included in a data transmission time window of each DRX cycle. Therefore, the terminal device may select an SR resource and/or a PRACH resource in a time period. This helps the terminal device to effectively determine the SR resource and/or the PRACH resource. Duration of the time period is longer than duration of the data transmission time window. A start moment of the time period is a moment at which the terminal device needs to request the second resource.

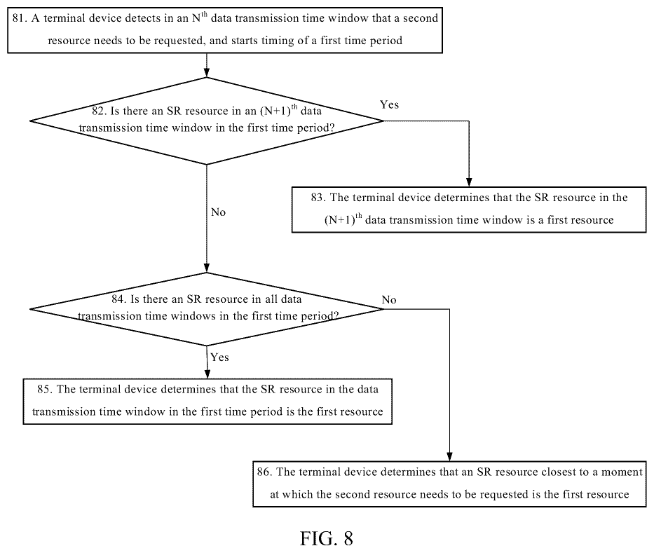

For example, taking SR resources as an example, a method for determining the first resource is described with reference to FIG. 8. It can be understood that in this case, the network device configures periodic SR resources for the terminal device. The terminal device may determine the first resource based on an SR resource in a first time period. The first time period is a time period for detecting the SR resource. Duration of the first time period is longer than the duration of the data transmission time window. A start moment of the first time period is the moment at which the terminal device needs to request the second resource. The duration of the first time period may be predefined through a protocol or indicated to the terminal device by the network device. This is not limited.

FIG. 8 is a schematic flowchart of a method for determining a first resource according to an embodiment of the present disclosure. The method specifically includes the following steps:

In step 81, a terminal device detects in an N^{th} data transmission time window that a second resource needs to be requested, and starts timing of a first time period.

In step 82, the terminal device determines whether there is an SR resource in an (N+1)^{th} data transmission time window in the first time period. If there is an SR resource in an (N+1)^{th} data transmission time window in the first time period, step 83 is performed. If there is no SR resource in an (N+1)^{th} data transmission time window in the first time period, step 84 is performed.

In step 83, the terminal device determines that the SR resource in the (N+1)^{th} data transmission time window is a first resource.

In step 84, the terminal device determines whether there is an SR resource in all data transmission time windows in the first time period. If there is an SR resource in all data transmission time windows in the first time period, step 85 is performed. If there is no SR resource in all data transmission time windows in the first time period, step 86 is performed.

In step 85, the terminal device determines that the SR resource in the data transmission time window in the first time period is the first resource.

In step 86, the terminal device determines that an SR resource closest to a moment at which the second resource needs to be requested is the first resource. It can be understood that the SR resource closest to the moment at which the second resource needs to be requested may be an SR resource located in a data transmission time window or an SR resource located outside a data transmission time window. This is not particularly limited in the embodiments of the present disclosure.

It can be understood that for a manner in which the terminal device determines the first resource based on a PRACH resource in a time period, reference may be made to a manner in which the terminal device determines the first resource based on an SR resource in a time period. Details are not described herein.

It should be noted that the manner in which the terminal device determines the first resource based on the PRACH resource in the time period and the manner in which the terminal device determines the first resource based on the SR resource in the time period may be both used. For example, if the network device configures both periodic SR resources and PRACH resources for the terminal device, the terminal device may determine the first resource based on the SR resource and the PRACH resource in the first time period.

Alternatively, the manner in which the terminal device determines the first resource based on the PRACH resource in the time period and the manner in which the terminal device determines the first resource based on the SR resource in the time period may be separately used. For example, if the network device configures only periodic SR resources for the terminal device, the terminal device may determine the first resource based on the SR resource in the first time period. If the network device does not configure periodic SR resources but configures periodic PRACH resources for the terminal device, the terminal device may determine the first resource based on the PRACH resource in the first time period.

In some other embodiments of the present disclosure, after the terminal device requests the second resource by using an SR resource in a data transmission time window for the first time but receives no resource configuration information from the network device, an SR resource used by the terminal device to request the second resource from the network device again is also located in a data transmission time window.

Alternatively, after the terminal device requests the second resource by using a PRACH resource in a data transmission time window for the first time but receives no resource configuration information from the network device, a PRACH resource used by the terminal device to request the second resource from the network device again is also located in a data transmission time window.

In some other embodiments of the present disclosure, the terminal device may first start a timer and request the second resource by using an SR resource in a data transmission time window within a valid time range of the timer. After the timer expires, the terminal device may request the second resource from the network device by using an SR resource in any time period. The timer may be started when the terminal device determines that there is uplink information to be sent. Duration of the timer may be predefined through a protocol or indicated to the terminal device by the network device. This is not limited.

Alternatively, the terminal device may first start a timer and request the second resource by using a PRACH resource in a data transmission time window within a valid time range of the timer. After the timer expires, the terminal device may request the second resource from the network device by using a PRACH resource in any time period.

For example, taking SR resources as an example, the terminal device starts a first timer when determining that there is uplink information to be sent. Duration of the first time period may be predefined through a protocol or indicated to the terminal device by the network device. This is not limited. If the first timer does not expire and the terminal device requests the second resource by using an SR resource in a data transmission time window but receives no resource configuration information used to indicate the second resource from the network device, the terminal device may continue to request the second resource by using an SR resource in a data transmission time window. If the first timer expires and the terminal device still receives no resource configuration information used to indicate the second resource from the network device, the terminal device may request the second resource from the network device by using an SR resource in any time period.

It can be understood that for a manner in which the terminal device determines the first resource based on a PRACH resource of a timer, reference may be made to a manner in which the terminal device determines the first resource based on an SR resource of a timer. Details are not described herein.

In addition, in some embodiments, the network device sends resource request configuration information to the terminal device. The resource request configuration information is used to indicate requesting an uplink resource by using the SR resource and/or the PRACH resource. Alternatively, requesting the uplink resource by using the SR resource and/or the PRACH resource may be predefined through a protocol.

It should be noted that if a sleep period is before an active period for one DRX cycle, as shown in FIG. 1b, the terminal device detects in an N^{th} DRX sleep period that there is uplink information to be sent, and an amount of resources actually available to send the uplink information does not meet an amount of resources required to send the uplink information, the terminal device may request the uplink resource from the network device by using an SR resource and/or a PRACH resource in an N^{th} DRX active period. That is, the terminal device may request the uplink resource from the network device by using an SR resource and/or a PRACH resource in a data transmission time window of an N^{th} DRX cycle.

Alternatively, if the sleep period is before the active period, the terminal device detects in the N^{th} DRX sleep period that there is uplink information to be sent, and the amount of resources actually available to send the uplink information does not meet the amount of resources required to send the uplink information, the terminal device may request the uplink resource from the network device by using an SR resource and/or a PRACH resource in an (N+1)^{th} DRX active period. That is, the terminal device may request the uplink resource from the network device by using an SR resource and/or a PRACH resource in a data transmission time window of an (N+1)^{th} DRX cycle.

In the embodiments of the present disclosure, the first resource located in the data transmission time window is determined and the uplink resource is requested by using the first resource located in the data transmission time window, to help to reduce additional power consumption caused by requesting the uplink resource by the terminal device, and further help to reduce power consumption of the terminal device.

The foregoing embodiments may be used independently or may be combined with each other to achieve different technical effects.

In the foregoing embodiments provided in the present disclosure, the communication method provided in the embodiments of the present disclosure is introduced from perspectives of the network device and the terminal device as execution bodies. In order to implement the functions in the communication method provided in the foregoing embodiments of the present disclosure, the terminal device and the network device may include a hardware structure and/or a software module to implement the functions in the form of the hardware structure, the software module, or the hardware structure in combination with the software module. Whether one of the functions is implemented in the form of the hardware structure, the software module, or the hardware structure in combination with the software module depends on particular applications and design constraints of the technical solutions.

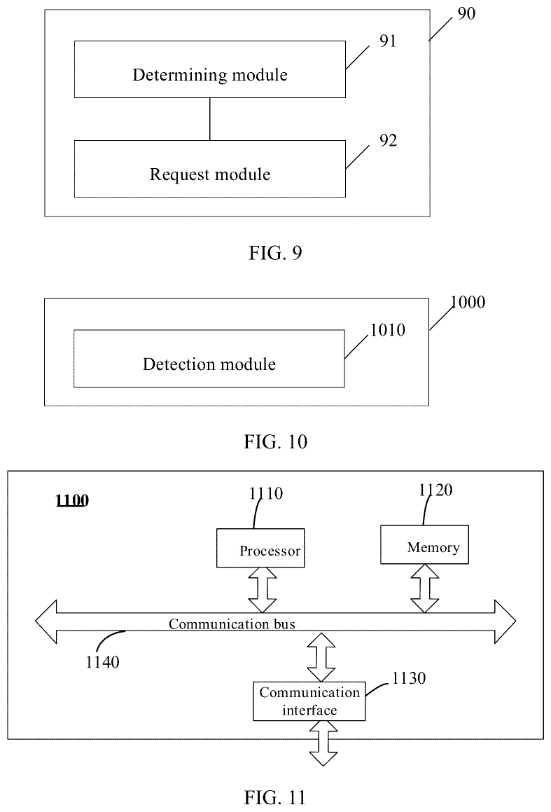

FIG. 9 is a schematic structural diagram of a communication apparatus 90 according to an embodiment of the present disclosure, which may include a determining module 91 and a request module 92.

The determining module 91 is configured to determine, by a terminal device, a first resource. The first resource is located in a data transmission time window. The data transmission time window is used to receive downlink information.

The request module 92 is configured to request, by the terminal device, a second resource from a network device by using the first resource. The second resource is used to send uplink information.

In an embodiment, the determining module 91 is further configured to determine, by the terminal device, that an amount of resources required to send the uplink information exceeds an amount of resources actually available to send the uplink information.

In an embodiment, the determining module 91 is further configured to determine, by the terminal device, that there is uplink information to be sent.

In an embodiment, the determining module 91 is further configured to determine, by the terminal device, that no resource is available to send the uplink information.

In an embodiment, the first resource is located in an N^{th} data transmission time window. The N^{th} data transmission time window is used to receive a K^{th} TB. The first resource is used to send HARQ information of the K^{th} TB. N and K are positive integers.

In an embodiment, the communication apparatus 90 further includes: a receiving module 93.

The receiving module 93 is configured to receive, by the terminal device, first indication information from the network device, where the first indication information is used to indicate K.

In an embodiment, the first resource includes a first sub-resource and a second sub-resource. The first sub-resource and the second sub-resource are used to send the HARQ information of the K^{th} TB.

In an embodiment, the request module 92 is further configured to send, by the terminal device, the HARQ information of the K^{th} TB by using the first sub-resource.

In an embodiment, the request module 92 is further configured to: if the terminal device does not need to request the second resource, send, by the terminal device, the HARQ information of the K^{th} TB by using the second sub-resource.

In an embodiment, the request module 92 is further configured to send, by the terminal device, a resource request message to the network device on the first resource. The resource request message is used to request the second resource.

In an embodiment, the receiving module 93 is further configured to receive, by the terminal device, uplink resource request configuration information from the network device. The uplink resource request configuration information is used to indicate requesting the second resource by using the first resource.

In an embodiment, the receiving module 93 is further configured to receive, by the terminal device, resource configuration information from the network device. The resource configuration information is used to indicate the second resource.

In an embodiment, the request module 92 is further configured to send, by the terminal device, a random access request to the network device if the terminal device requests the second resource by using M first resources but still receives no resource configuration information from the network device. The random access request is used to request the second resource. M is a positive integer.

In an embodiment, the first resource is an SR resource and/or a PRACH resource.

In an embodiment, the determining module 91 is further configured to: if the SR resource and the PRACH resource are included in the data transmission time window, determine, by the terminal device, that the SR resource is the first resource; if the SR resource and the PRACH resource are included in the data transmission time window, determine, by the terminal device, that the SR resource and the PRACH resource are the first resource; or if the SR resource and the PRACH resource are included in the data transmission time window, determine, by the terminal device based on a configuration of the network device, that the SR resource or the PRACH resource is the first resource.

In an embodiment, the data transmission time window is located in a first time period. Duration of the first time period is longer than duration of the data transmission time window. A start moment of the first time period is a moment at which the terminal device needs to request the second resource.

In an embodiment, the determining module 91 is further configured to: if there is no SR resource in the data transmission time window in the first time period and/or no PRACH resource in the data transmission time window in the first time period, determine, by the terminal device, that an SR resource and/or a PRACH resource closest to the moment at which the terminal device needs to request the second resource is the first resource.

In an embodiment, the request module 92 is further configured to: in response to expiring of a first timer, if the terminal device still receives no resource configuration information used to indicate the second resource from the network device, request, by the terminal device, the second resource from the network device by using an SR resource and/or a PRACH resource in any time period. The first timer starts when the terminal device determines that there is uplink information to be sent.

In an embodiment, the communication apparatus 90 may be a chip or a terminal device.

FIG. 10 is a schematic structural diagram of a communication apparatus 1000 according to an embodiment of the present disclosure, which may include a detection module 1010.

The detection module 1010 is configured to detect, by a network device by using a first resource, that a terminal device requests a second resource. The first resource is located in a data transmission time window. The data transmission time window is used to send downlink information. The second resource is used to send uplink information.

In a possible implementation, the communication apparatus 1000 further includes: a sending module 1020.

The sending module 1020 is configured to send, by the network device, uplink resource request configuration information to the terminal device. The uplink resource request configuration information is used to indicate requesting the second resource by using the first resource.

In an embodiment, the first resource is located in an N^{th} data transmission time window. The N^{th} data transmission time window is used to send a K^{th} TB. The first resource is used to send HARQ information of the K^{th} TB. N and K are positive integers.

In an embodiment, the sending module 1020 is further configured to send, by the network device, first indication information to the terminal device. The first indication information is used to indicate K.

In an embodiment, the first resource includes a first sub-resource and a second sub-resource. The first sub-resource and the second sub-resource are used to send the HARQ information of the K^{th} TB.

In an embodiment, the detection module 1010 is further configured to: if the network device receives the HARQ information of the K^{th} TB on the first sub-resource, determine, by the network device, that a request of the terminal device for the second resource is detected.

In an embodiment, the detection module 1010 is further configured to: if the network device receives the HARQ information of the K^{th} TB on the second sub-resource, determine, by the network device, that no request of the terminal device for the second resource is detected.

In an embodiment, the detection module 1010 is further configured to receive, by the network device, a resource request message from the terminal device on the first resource. The resource request message is used to request the second resource.

In an embodiment, the sending module 1020 is further configured to send, by the network device, resource configuration information to the terminal device. The resource configuration information is used to indicate the second resource.

In an embodiment, the first resource is an SR resource and/or a PRACH resource.

In an embodiment, the sending module 1020 is further configured to send, by the network device, priority indication information to the terminal device. The priority indication information indicates a priority of using the SR resource and a priority of using the PRACH resource to request the second resource.

In an embodiment, the data transmission time window is located in a first time period. Duration of the first time period is longer than duration of the data transmission time window. A start moment of the first time period is a moment at which the terminal device needs to request the second resource.

In an embodiment, the sending module 1020 is further configured to send, by the network device, window adjustment indication information to the terminal device. The window adjustment indication information indicates aligning a start moment of a DRX window with a moment at which the downlink information arrives.

In an embodiment, the communication apparatus 1000 may be a chip or a network device.

FIG. 11 is a schematic structural diagram of a communication apparatus 1100 according to an embodiment of the present disclosure. The communication apparatus 1100 may include at least one processor and at least one memory communicatively connected to the processor. The communication apparatus 1100 may be a network device or a terminal device. The memory stores a program instruction executable by the processor. If the communication apparatus 1100 is the network device, the processor calls the program instruction to perform the actions performed by the network device in the communication method provided in the embodiments of the present disclosure. If the communication apparatus 1100 is the terminal device, the processor calls the program instruction to perform the actions performed by the terminal device in the communication method provided in the embodiments of the present disclosure.

As shown in FIG. 11, the communication apparatus 1100 may be in the form of a general-purpose computing device. Components of the communication apparatus 1100 may include, but are not limited to, one or more processors 1110, a memory 1120, a communication bus 1140 that connects various system components (including the memory 1120 and the processors 1110), and a communication interface 1130.

The communication bus 1140 represents one or more of several types of bus architectures, including a memory bus or a memory controller, a peripheral bus, an accelerated graphics port, a processor, or a local bus using any of various bus architectures. For example, these architectures include, but are not limited to, an industry standard architecture (ISA) bus, a micro channel architecture (MAC) bus, an enhanced ISA bus, a Video Electronics Standards Association (VESA) local bus, and a peripheral component interconnect (PCI) bus.

The communication apparatus 1100 typically includes various computer system-readable media. These media may be any available media that can be accessed by the communication apparatus 1100 and includes both volatile and non-volatile media, and removable and non-removable media.

The memory 1120 may include a computer system-readable medium in the form of a volatile memory, such as a random access memory (RAM) and/or a cache memory. The communication apparatus 1100 may further include other removable/non-removable and volatile/non-volatile computer system storage media. Although not shown in FIG. 11, a magnetic disk drive for reading from and writing to a removable non-volatile magnetic disk (for example, a “floppy disk”) and an optical disc drive for reading from and writing to a removable non-volatile optical disc (for example, a compact disk read-only memory (CD-ROM), a digital versatile disc read-only memory (DVD-ROM), or another optical medium) may be provided. In these cases, each drive may be connected to the communication bus 1140 through one or more data medium interfaces. The memory 1120 may include at least one program product having a set of (for example, one or more) program modules configured to implement functions in the embodiments of the present disclosure.

A program/utility having a set of (one or more) program modules may be stored in the memory 1120. The program modules include, but are not limited to, an operating system, one or more applications, other program modules, and program data. Each of these examples or some combination thereof may include an implementation of a network environment. The program modules usually implement the functions and/or methods in the embodiments described in the present disclosure.

The communication apparatus 1100 may further communicate with one or more external devices (for example, a keyboard, a pointing device, or a display), one or more devices that enable a user to interact with the communication apparatus 1100, and/or any device that enables the communication apparatus 1100 to communicate with one or more other computing devices (for example, a network card or a modem). Such communication may be performed through the communication interface 1130. In addition, the communication apparatus 1100 may communicate with one or more networks (for example, a local area network (LAN), a wide area network (WAN), and/or a public network such as the Internet) through a network adapter (not shown in FIG. 11). The network adapter may communicate with other modules of an electronic device through the communication bus 1140. It should be understood that although not shown in FIG. 11, other hardware and/or software modules may be used in combination with the communication apparatus 1100, including but not limited to microcode, a device driver, a redundant processing unit, an external disk drive array, a redundant arrays of independent disks (RAID) system, a tape driver, and a data backup storage system.

Based on the descriptions of the implementations, a person skilled in the art may clearly understand that for the purpose of convenient and brief descriptions, division into the foregoing functional modules is merely used as an example for descriptions. During actual application, the functions may be allocated to different functional modules for implementation based on a requirement. In other words, an inner structure of an apparatus is divided into different functional modules to implement all or some of the functions described above. For a specific working process of the system, apparatus, and unit described above, reference may be made to the corresponding process in the foregoing method embodiments. Details are not described herein again.

Functional units in the embodiments of the present disclosure may be integrated into one processing unit, each of the units may exist alone physically, or two or more units are integrated into one unit. The integrated unit may be implemented in a form of hardware or in a form of a software functional unit.

The integrated unit, if implemented in the form of a software functional unit and sold or used as a stand-alone product, may be stored in a computer-readable storage medium. Based on this understanding, the technical solutions in the embodiments of the present disclosure, in essence or the part contributing to the prior art, or some or all of the technical solutions may be embodied in a form of a software product. The computer software product is stored in a storage medium, and includes a plurality of instructions for enabling a computer device (which may be a personal computer, a server, a network device, or the like) or a processor to perform all or some steps of the method in the embodiments of the present disclosure. The storage medium includes any medium that can store program code, such as a flash memory, a removable hard disk, a read-only memory (ROM), a RAM, a magnetic disk, or an optical disc.

The foregoing descriptions are merely specific implementations of the present disclosure, but are not intended to limit the protection scope of the present disclosure. Any variation or replacement within the technical scope disclosed in the present disclosure shall fall within the protection scope of the present disclosure. Therefore, the protection scope of the present disclosure shall be subject to the protection scope of the claims.

1. A communication method, comprising:
determining, by a terminal device, a first resource, wherein the first resource is located in a data transmission time window, and the data transmission time window is used to receive downlink information; and
requesting, by the terminal device, a second resource from a network device using the first resource, wherein the second resource is used to send uplink information.

2. The method according to claim 1, further comprising:
determining, by the terminal device, that an amount of resources required to send the uplink information exceeds an amount of resources available to send the uplink information.

3. (canceled)

4. The method according to claim 1, further comprising:
determining, by the terminal device, that no resource is available to send the uplink information.

5. The method according to claim 1, wherein that the first resource is located in the data transmission time window and the data transmission time window is used to receive the downlink information comprises:
the first resource is located in an N^{th} data transmission time window, the N^{th} data transmission time window is used to receive a K^{th} transport block (TB), and the first resource is used to send hybrid automatic repeat request (HARQ) information of the K^{th} TB, wherein N and K are positive integers.

6. The method according to claim 5, further comprising: receiving, by the terminal device, first indication information from the network device, wherein the first indication information is used to indicate the K.

7. The method according to claim 5, wherein the first resource comprises a first sub-resource and a second sub-resource, and the first sub-resource and the second sub-resource are used to send the HARQ information of the K^{th} TB.

8. The method according to claim 7, wherein said requesting, by the terminal device, the second resource from the network device using the first resource comprises:
sending, by the terminal device, the HARQ information of the K^{th} TB using the first sub-resource.

9. The method according to claim 8, further comprising: in response to determining that the terminal device does not need to request the second resource, sending, by the terminal device, the HARQ information of the K^{th} TB using the second sub-resource.

10. The method according to claim 1, wherein said requesting, by the terminal device, the second resource from the network device using the first resource comprises:
sending, by the terminal device, a resource request message to the network device on the first resource, wherein the resource request message is used to request the second resource.

11. The method according to claim 1, further comprising: receiving, by the terminal device, uplink resource request configuration information from the network device, wherein the uplink resource request configuration information is used to indicate requesting the second resource using the first resource.

12. The method according to claim 1, further comprising: receiving, by the terminal device, resource configuration information from the network device, wherein the resource configuration information is used to indicate the second resource.

13. The method according to claim 12, further comprising: sending, by the terminal device, a random access request to the network device if the terminal device requests the second resource by using M first resources but still receives no resource configuration information from the network device, wherein the random access request is used to request the second resource, and M is a positive integer.

14. (canceled)

15. The method according to claim 1, wherein said determining, by the terminal device, the first resource comprises:
if the SR resource and the PRACH resource are comprised in the data transmission time window, determining, by the terminal device, that the SR resource is the first resource.

16. The method according to claim 1, wherein the data transmission time window is located in a first time period, a duration of the first time period is longer than a duration of the data transmission time window, and a start moment of the first time period is a moment at which the terminal device requires to request the second resource.

17. The method according to claim 16, wherein said determining, by the terminal device, the first resource comprises:
if there is no SR resource in any data transmission time window in the first time period and/or no PRACH resource in any data transmission time window in the first time period, determining, by the terminal device, that an SR resource and/or a PRACH resource closest to the moment at which the terminal device requires to request the second resource is the first resource.

18. The method according to claim 14, further comprising: in response to expiring of a first timer, if the terminal device still receives no resource configuration information used to indicate the second resource from the network device, requesting, by the terminal device, the second resource from the network device using an SR resource and/or a PRACH resource in any time period, wherein the first timer starts when the terminal device determines that there is uplink information to be sent.

19-31. (canceled)

32. A communication apparatus, comprising a processor and a memory, wherein the memory is configured to store a computer program; and the processor is configured to run the computer program to perform a communication method, wherein the communication method comprises:
determining a first resource, wherein the first resource is located in a data transmission time window, and the data transmission time window is used to receive downlink information; and
requesting a second resource from a network device using the first resource, wherein the second resource is used to send uplink information.

33-37. (canceled)

38. A non-transitory computer-readable storage medium, wherein the computer-readable storage medium stores a computer program, and the computer program, when run on a computer, performs a communication method, wherein the communication comprises:
determining, by a terminal device, a first resource, wherein the first resource is located in a data transmission time window, and the data transmission time window is used to receive downlink information; and
requesting, by the terminal device, a second resource from a network device using the first resource, wherein the second resource is used to send uplink information.

39. The method according to claim 1, wherein said determining, by the terminal device, the first resource comprises:
if the SR resource and the PRACH resource are comprised in the data transmission time window, determining, by the terminal device, that the SR resource and the PRACH resource are the first resource.

40. The method according to claim 1, wherein said determining, by the terminal device, the first resource comprises:
if the SR resource and the PRACH resource are comprised in the data transmission time window, determining, by the terminal device based on a configuration of the network device, the first resource from the SR resource and the PRACH resource.
